(19) United States
(12) Patent Application Publication
(10) Pub. No.: US 2025/0384408 A1
(43) Pub. Date: Dec. 18, 2025

(54) SYSTEMS AND METHODS FOR SMART HOME MAINTENANCE

(71) Applicant: State Farm Mutual Automobile Insurance Company, Bloomington, IL (US)

(72) Inventor: Phillip M. Wilkowski, Gilbert, AZ (US)

(21) Appl. No.: 18/765,994

(22) Filed: Jul. 8, 2024

Related U.S. Application Data
(60) Provisional application No. 63/659,179, filed on Jun. 12, 2024.

(51) Int. Cl. G06Q 10/20; G06Q 10/1093; H04L 12/28

(52) U.S. Cl. CPC G06Q 10/20; G06Q 10/1093; H04L 12/2823

(57) ABSTRACT

Smart home-related technology is provided. A computer system is programmed to: a) receive a plurality of sensor information for a first location; b) identify a first item at the first location based upon the plurality of sensor information; c) determine one or more maintenance tasks and a schedule for the one or more maintenance tasks for the first item; d) receive a plurality of new information about the first item; e) adjust the schedule for the one or more maintenance tasks based upon the received plurality of new information; and/or f) transmit at least one notification for the one or more maintenance tasks to a user computer device associated with a user associated with the first location.

### CROSS REFERENCE TO RELATED APPLICATIONS

This application claims priority to U.S. Provisional Patent Application No. 63/659,179, filed on Jun. 12, 2024, which is hereby incorporated by reference in its entirety.

### FIELD OF THE DISCLOSURE

The field of the invention relates generally to smart home maintenance systems, and more specifically, to a network-based computer system and method for monitoring appliances and structures of a home to schedule and monitor for recurring maintenance tasks.

### BACKGROUND

Residential homeowners may be generally concerned about taking care of their homes. For example, homeowners may be concerned about their homes being damaged from a natural disaster or damaged in other ways. Many different types of disasters may result in damage to a residential home, from acts of nature such as flooding, lightning, tornados, or hurricanes, to electrical fires caused by failing appliances or electrical connections, to home security risks such as theft or vandalism.

Many of these disasters may be present or more likely to occur due to inherent factors not easily controlled or mitigated by the homeowner, but avoiding or minimizing some of these risks may be addressed by the homeowner. Homeowners may be able to reduce the likelihood of damage to their homes by performing certain mitigating actions, such as maintenance actions.

However, homeowners may often be unaware of needed maintenance tasks, such as by forgetting a task that may only occur once every three months, etc. Furthermore, use of items within the home and/or other conditions within the home may affect how often the maintenance tasks are needed to be performed. For example, in the case where homes in a certain location have experienced smoke from wildfires, after the smoke from such wildfires has moved to a different location, people in those impacted areas where the wildfires had been experienced would likely have needed to change their air filters within their homes ahead of the normal schedule of changing air filters.

What is needed is an intelligent system for monitoring when different maintenance tasks are needed to be performed within a home and notifying the user/homeowner of those tasks. By properly performing maintenance within a home, the user/homeowner may improve (i) the overall health of the home, and/or (ii) the lifespan of the home and many of the items contained therein. Conventional techniques may include additional inefficiencies, encumbrances, ineffectiveness, and/or other drawbacks as well.

### BRIEF DESCRIPTION

The present embodiments may relate to, inter alia, systems and methods for smart home maintenance systems. As described herein, the exemplary system may include a remote system server, a home controller, a third-party server, and one or more sensors positions throughout or proximate to a home. The home controller may be installed within a predesignated location, and may be configured to receive data from the one or more devices via a network. The data may reflect an aspect of operational quality of one or more assets of the location including the home structure and/or items located within or near or associated with the home.

In one aspect, the remote system server may be configured to communicate with the home controller and one or more external data sources outside the residential property via an external network. The remote system server may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the remote system server may include one or more processors and/or associated transceivers programmed to: (i) receive a plurality of sensor information for a first location; (ii) identify a first item at the first location based upon the plurality of sensor information; (iii) determine one or more maintenance tasks and a schedule for the one or more maintenance tasks for the first item; (iv) receive a plurality of new information about the first item; (v) adjust the schedule for the one or more maintenance tasks based upon the received plurality of new information; and/or (vi) transmit at least one notification for the one or more maintenance tasks to a user computer device associated with a user associated with the first location. The remote system server may have additional, less, or alternate functionality, including that discussed elsewhere herein.

In another aspect, a computing device for smart home maintenance may be provided. The computing device may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computing device may include at least one processor and/or associated transceiver programmed to: (i) receive a first element of home data from the home controller; (ii) determine a safety score for the residential property based at least in part on the first element of home data, the safety score representing a measure of safety of the residential property; (iii) receive a first element of external data from the one or more external data sources, the first element of external data relating to a geographical region of the residential property; (iv) determine a home health score for the residential property based at least in part on one or more of the first element of home data provided by the one or more smart devices and the first element of external data from the one or more external data sources, the home health score representing a measure of health of the residential property; (v) determine at least one product provider and service provider to be able to improve the home health score based at least in part upon the first element of home data and the first element of external data; and/or (vi) cause to be displayed, to a homeowner of the residential property via a graphical user interface, information about the at least one product provider and service provider to improve the home health score. The computing device may have additional, less, or alternate functionality, including that discussed elsewhere herein.

In yet another aspect, a computer-based or computer-implemented method of evaluating and mitigating aspects of a residential property may be provided. The computer-implemented method may be implemented using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the computer-implemented method may be performed by a computing device including at least one processor and/or associated transceiver. The method may include, via the at least one processor and/or associated transceiver: (i) receiving, by the one or more processors, a plurality of sensor information for a first location; (ii) identifying, by the one or more processors, a first item at the first location based upon the plurality of sensor information; (iii) determining, by the one or more processors, one or more maintenance tasks and a schedule for the one or more maintenance tasks for the first item; (iv) receiving, by the one or more processors, a plurality of new information about the first item; (v) adjusting, by the one or more processors, the schedule for the one or more maintenance tasks based upon the received plurality of new information; and/or (vi) transmitting, by the one or more processors, at least one notification for the one or more maintenance tasks to a user computer device associated with a user associated with the first location. The method may have additional, less, or alternate actions, including that discussed elsewhere herein.

In still another aspect, a non-transitory computer readable medium having computer-executable instructions embodied thereon for evaluating aspects of health of a residential property is provided. When executed by at least one processor and/or associated transceiver, the computer-executable instructions cause the at least one processor and/or associated transceiver to: (i) receive a plurality of sensor information for a first location; (ii) identify a first item at the first location based upon the plurality of sensor information; (iii) determine one or more maintenance tasks and a schedule for the one or more maintenance tasks for the first item; (iv) receive a plurality of new information about the first item; (v) adjust the schedule for the one or more maintenance tasks based upon the received plurality of new information; and/or (vi) transmit at least one notification for the one or more maintenance tasks to a user computer device associated with a user associated with the first location. The computer readable medium may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings discussed herein certain arrangements. However, it should be understood that the present embodiments are not limited to the precise arrangements and/or instrumentalities shown herein.

FIG. 1 is a diagram illustrating an exemplary home maintenance monitoring (HMM) system for monitoring and analyzing property in accordance with at least one embodiment of this disclosure.

FIG. 2 depicts a flow chart of an exemplary computer-implemented process for monitoring and analyzing property using the system shown in FIG. 1.

FIG. 3 is a diagram illustrating exemplary source devices that may be used with the HMM systems shown in FIG. 1.

FIG. 4 is a diagram illustrating an exemplary computer system for implementing the home maintenance monitoring (HMM) system shown in FIG. 1 performing the process shown in FIG. 2.

FIG. 5 depicts an exemplary configuration of a client computer device shown in FIG. 1 in accordance with one embodiment of the present disclosure.

FIG. 6 depicts an exemplary configuration of a server shown in FIG. 1 in accordance with one embodiment of the present disclosure.

FIGS. 7-9 are exemplary screen shots or user interfaces for a home maintenance monitoring (HMM) application that may be displayed on a user device executing the HMM application.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, network-based computer systems and methods for monitoring devices, appliances, and/or structures (collectively referred to herein as items) of a home to schedule and/or monitor those items for recurring maintenance tasks. As used herein, the terms residential housing or home may mean a house, a condominium, an apartment, or any other property that may include a structure that can be used for shelter. In one exemplary embodiment, a home maintenance monitoring (HMM) system monitors different sensors in or around or proximate to a home to detect when different appliances or items are used in the home and uses that information to determine modifications to any maintenance schedules for the appliances or items. In some embodiments, the HMM system calculates a usage score or severity score for the condition of the corresponding appliance or items and uses that score to determine when maintenance should occur. Furthermore, in various embodiments, the HMM system may use usage time and/or weather data to determine the score.

In the exemplary embodiment, items and/or appliances (generally referred to herein as items) that may need maintenance tasks to be performed thereon include, but are not limited to, HVAC (heating, ventilation, and air conditioning), appliances (including smart appliances), washing machines, dryers, refrigerators, stoves, ovens, microwaves, solar panels, garage door openers, security systems, garbage disposals, outdoor or indoor pools, solar panels, security systems, roofs, gutters, IoT (Internet of Things) devices, etc.

In the exemplary embodiment, the HMM system may maintain a calendar of maintenance tasks for items in a home. The maintenance tasks may include tasks that need to be performed on a periodic basis, such as but not limited to, replacing air filters, cleaning gutters, having different appliances serviced, or having other items maintained, etc. Then the HMM system may determine an amount of usage for the corresponding items and makes modifications to the dates for the tasks based upon how the amount of usage would necessitate sooner maintenance.

In the exemplary embodiment, the HMM system may transmit notifications about upcoming and needed maintenance tasks to one or more user devices associated with the user/homeowner. In some further embodiments, the HMM system may provide links to phone numbers, websites, email addresses, etc. of service providers to assist the user/homeowner in performing the maintenance tasks. For example, if it is time to clean the gutters, then the HMM system may provide the contact information for the service provider that cleaned the gutters previously. The HMM system may also provide the contact information for a service provider that is offering a special or savings on performing that maintenance task.

In some embodiments, the HMM system may determine which items are in the home based upon listening to the noises in the home through different devices with microphones to identify the items that may need maintenance in the home. The HMM system may use microphones on smart devices, such as smartphones, home controllers, devices with verbal interaction capabilities, speakers, voice bots, chatbots, etc. The HMM system may also use images of the home and perform image recognition to identify items that may need maintenance.

In other embodiments, the HMM system may use one or more sensors to perform a LIDAR (Light Detection and Ranging) scan of the home to identify the items. In further embodiments, the HMM system may communicate with a wireless or wired network in the home to identify the items that may need maintenance connected to the network. In still further embodiments, the HMM system may use electricity monitoring systems to determine which items that may need maintenance are in the home and the usage of those items.

In some further embodiments, the HMM system may use artificial intelligence/machine learning (AI/ML) tools to identify the items that may need maintenance in the home. In these embodiments, the AI/ML tools have been trained to identify items that may need maintenance based upon noises, images, electricity usage patterns, LIDAR imaging, etc. In some of these embodiments, the HMM system may generate a model of the home and the items that may need maintenance in the home. In these embodiments, the HMM system may also use the AI/ML tools to determine the condition of the identified items and/or identify when maintenance tasks are needed.

In the exemplary embodiments, the HMM server provides a single application platform for users to monitor multiple different systems/devices to notify the user/homeowner when maintenance tasks are due. The HMM server may provide the HMM application that provides a simplified experience while bringing visibility to needed maintenance tasks and associated services available through the HMM application. The HMM application may allow the user to view and monitor all aspects of their home and home related services from one place. This also allows the HMM server to know which devices the user has connected and then to monitor those devices.

The home maintenance monitoring (HMM) system may collect some home data from external sources (e.g., publicly available data, such as historical weather-related information or power outage statistics for the area, emergency service response statistics for the area, or the like) or from home sources (e.g., data gathered from sensors, appliances, IoT devices, or networked devices within and/or around the house). The homeowner/user may also provide the HMM system with access to data from different monitors and other devices in the home, such as Internet of Things (IoT) devices. The IoT devices may provide their data directly and/or provide data through servers associated with and in communication with the IoT devices.

The HMM system may then analyze the provided data to, for example, alert appropriate or registered users of various projected or current risks to the home and maintenance tasks to mitigate those risks. As such, subject homes may include a home controller that is configured (e.g., on a home network) to communicate with various sensors, appliances, items, and other devices within the home and to relay home data to a remote system server (such as HMM server) for various uses discussed herein.

The HMA system may also be in communication with one or more marketplaces that provide access to and matching with companies that provide maintenance services to perform needed maintenance tasks for the home. Other examples of products and/or services provided by the marketplace include, but are not limited to, plumbers, smart home devices, security systems, maintenance, such as of a HVAC (heating, ventilation, and air conditioning) system, and/or insurance.

While various examples provided herein describe application of the HMM system to various aspects of homes, the systems and methods described herein may also be used for performing other analysis, such as vehicles, businesses, municipal locations, and/or other locations.

### Exemplary System for Monitoring and Analyzing Property

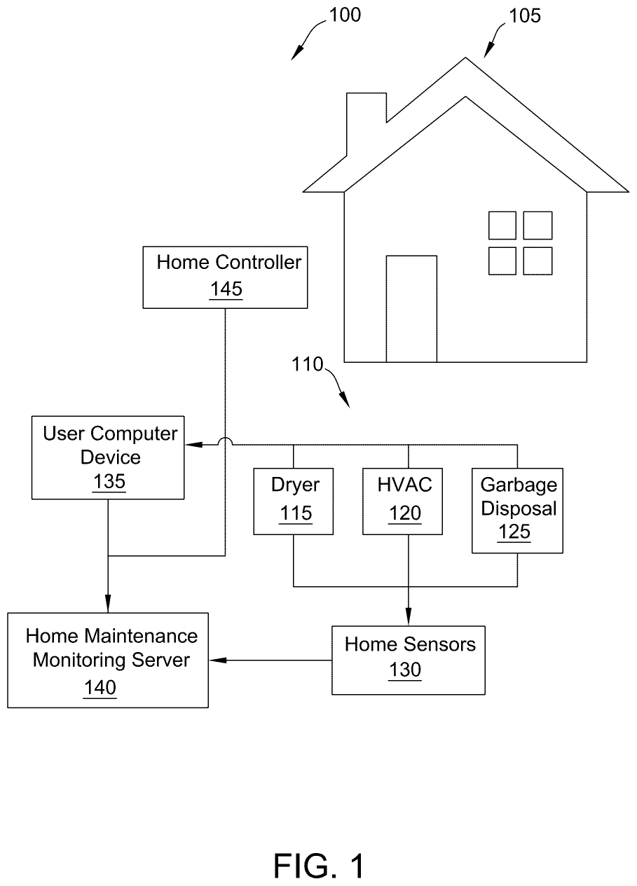

FIG. 1 illustrates an exemplary home maintenance monitoring (HMM) system 100 of monitoring and analyzing property, in accordance with at least one embodiment of this disclosure. System 100 illustrates monitoring and other devices to receive, analyze, and report the data collected about a property location, such as, but not limited to a home.

In the exemplary embodiment, a home 105 contains a plurality of items 110 that may need maintenance including, a dryer 115, HVAC system 120, and/or garbage disposal 125, for example. These items 110 may be in or around a home 105. Other examples of devices/items 110 include, but are not limited to, appliances, washing machines, refrigerators, stoves, ovens, microwaves, solar panels, garage door openers, security systems, outdoor or indoor pools, solar panels, security systems, roofs, gutters, IoT (Internet of Things) devices, etc.

In the exemplary embodiment, the home 105 may also include a plurality of home sensors 130. These sensors 130 measure different attributes of the home 105, including, but not limited to, monitoring noise, electrical usage, temperature, and/or any other sensor 130 to allow the HMM system 100 to identify items 110 in the home 105.

In the exemplary embodiment, a user computer device 135 may be used to identify items 110 in the home 105. The user computer device 135 may capture noises via its microphone, images via its camera, location via its GPS (Global Positioning System), and identify items 110 connected to a wireless network. The sensors 130 and the user computer device 135 transmit their collected information to a home maintenance monitoring (HMM) server 140, wherein the HMM server 140 is programmed to identify the items 110 from the provided data.

In some embodiments, the HMM server 140 may employ artificial intelligence/machine learning (AI/ML) tools to identify the items 110 in the home 105. In these embodiments, the AI/ML tools have been trained to identify devices 110 based upon noises, images, electricity usage patterns, LIDAR imaging, etc. In some of these embodiments, the HMM server 140 generates a model of the home 105 and the items 110 in the home 105. In these embodiments, the HMM server 140 may also use the AI/ML tools to determine the condition of the identified items 110 and/or identify when maintenance tasks are needed.

In some embodiments, the HMM server 140 may also be in communication with a home controller 145 for the home 105. The home controller 145 may be in communication with one or more items 110 in the home 105 and may provide information about those items 110 to the HMM server 140. The home controller 145 may also provide usage information about the items 110 to the HMM server 140.

In at least one embodiment, the home controller 145 may be in wired or wireless communication the one or more items 110 in the home 105. In some embodiments, the home controller 145 may be a router or Wi-Fi providing device in the home 105. In other embodiments, the home controller 145 may be a smart home controller that controls one or more of the devices 110 and may provide communication between the user and the individual items 110.

While various examples provided herein describe application of the HMM system to various aspects of homes, the systems and methods described herein may also be used for performing other analysis, such as vehicles, businesses, municipal locations, and/or other locations.

### Exemplary External Data Sources

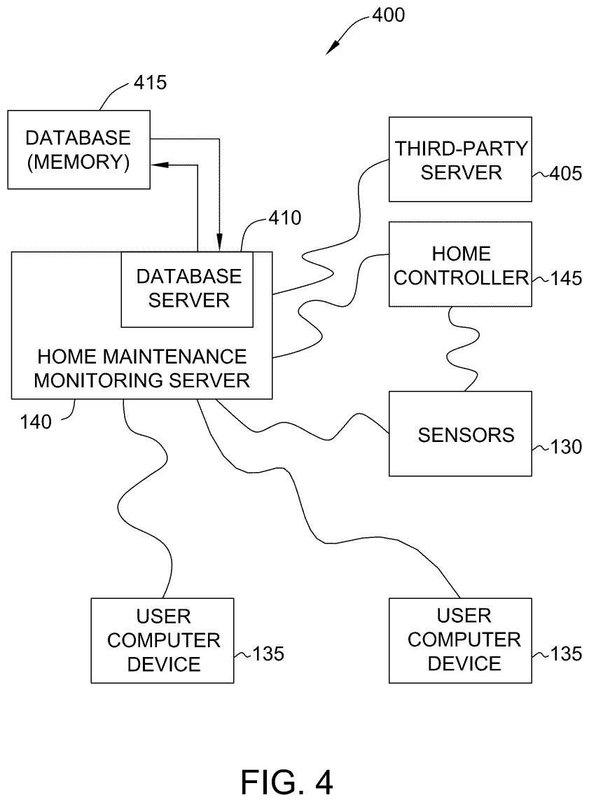

In the exemplary embodiment, and referring now to FIG. 1, the system 100 may collect various types of external data from external data sources, such as third-party servers 405 (shown in FIG. 4) that may be used, for example, for home or property monitoring, device identification, for generating maintenance recommendations, or other various uses described herein. Some third-party servers 405 may provide publicly available data, where other third-party servers 405 may be private, third-party sources. Third-party servers 405 may include an insurance provider that provides insurance policies to the homeowner and various data available or otherwise collected by that insurance provider. In some embodiments, the HMM server 140 may be operated by the insurance provider and the database may include data private to the insurance provider (e.g., customer data, policy information, or other proprietary information).

In the exemplary embodiment, one example third-party servers 405 is the NOAA or any of its various branches (e.g., the national weather service). The NOAA makes various weather data publicly available. As such, the system 100 may collect weather data from the NOAA. Such weather data may be refined to a particular geography, such as a state, county, city, or other geographic region. The system 100 may, for example, identify a geographic region of the home 105 and submit data queries to the NOAA for weather data specific to that geographic region. Such data queries may include requests for historical data such as average rainfall, storm occurrences, wind strengths, lightning strikes, temperatures, tornado events, or the like.

Historical data may be used to, for example, evaluate future risks to the home 105 over time. Data queries may include requests for forecast data such as severe watches warnings, tornado watches or warnings, flooding watches or warnings, precipitation predictions, wind predictions, lightning event predictions, blizzard warnings, or the like. Further, forecast data may be used to, for example, generate and send weather alerts to the homeowner or occupants of the home 105 or determine how frequently the home 105 experiences various warnings or alerts over time.

In the exemplary embodiment, another exemplary third-party server 405 may be the U.S. Forest Service. The U.S. Forest Service maintains historical data related to forest fires and tracks active forest fires in the United States. As such, the system 100 may collect forest fire data from the U.S. Forest Service. Such forest fire data may similarly be refined to a particular geography, such as a state, county, city, or other geographic region.

The system 100 may, for example, collect historical forest fire data for the geographic region of the home 105, may collect current forest fire data at or near the location of the home 105 (e.g., within a pre-defined distance from the home, within a distance from a projected path of the forest fire), or may collect forest-fire related smoke levels in the area of the home 105. The system 100 may use historical forest fire data to, for example, evaluate future risk of forest fires to the home 105. The system 100 may use current forest fire data to, for example, generate and send forest fire alerts to the homeowner or occupants of the home 105, smoke alerts, or as factors in maintenance task scheduling.

In the exemplary embodiment, another example third-party servers 405 may be municipal power utilities. The system 100 may access current or historical power network data provided by power utility companies in various localities, such as power generation performance statistics (e.g., generation and load statistics), power transmission and distribution statistics or power outage information (e.g., across the network, local to a distribution segment that services the home 105, consistencies of voltages, power sags, power surges, brown-outs or black-outs and associated frequencies or lengths of outages, or the like), lightning strike data affecting the power network, or electrical consumption data for the home 105 (e.g., current or historical power usage, local power generation provided back to the network). The system 100 may use current power network data to, for example, generate and send alerts to the homeowner during power outages (e.g., as SMS text messages or emails that may be viewed on mobile computing devices), or as factors in maintenance task scheduling.

In the exemplary embodiment, another example third-party servers 405 may be third-party home data systems such as Multiple Listings Service (“MLS”), Zillow (www.zillow.com), or other Internet-accessible sources for property data. The system 100 may access such home data systems to collect construction details about the home 105 such as, for example, the age of the home, how many bedrooms and bathrooms the home 105 has, the type of any HVAC, the square footage of the home 105, the size of the property, market price of the home, whether the home 105 is constructed of wood, brick, concrete, or the like, the type and size of any garage, the quality of materials used to construct the home 105, whether the home 105 has a basement, the type, age, or condition of plumbing or wiring inside and outside the home 105, whether the home 105 has a pool and safety fence around the pool, the type of roofing, the floor plan, the architecture of the home 105 (e.g., ranch, two story, split foyer), the type of flooring, the type of exterior (e.g., wood, brick, siding), type of local power generation on the property (e.g., solar, wind, generator), number of fire places, type of fencing or gutters, whether the home 105 has a pool, sheds, patios, porches, or other exterior structures, whether the home 105 has outside doors having steps, type of ducting and insulation within the home 105, type of landscaping around the home 105, or mobility or accessibility options within the home 105.

Some home statistics data may include geographic data about the home 105 such as, for example, school district information (e.g., public school system, school ratings), utility providers available to at the location (e.g., electric, gas, sewer, waste, recycling, phone, Internet, television, fire, police, hospital, or other city services), proximity data to various services and amenities (e.g., distances from schools, parks, grocery, gas, library, or sources of entertainment), hazard data for the area (e.g., crime statistics, natural disaster statistics, ratings for emergency services), Some home statistics data may include historical data, such as price history (e.g., sales history, listings history), public tax history, insurance claims history, home warranty information, home inspection information, lease information (e.g., whether and how often the home 105 has been partially or fully rented or leased), or the like. Some home statistics data may include home energy data such as, for example, whether the home 105 is energy certified, type and size of power generation, home appliance or lighting energy certification data, or the like.

In the exemplary embodiment, another example third-party servers 405 may be an insurance provider or other service provider that has an economic or consumer relationship with the homeowner. The system 100 may access the service provider systems to collect demographic details about the home 105 and its occupants, such as, for example, names or ages of the occupants, education levels or occupations of the occupants, whether any of the occupants smoke, a family emergency plan, community engagement of the occupants, or whether a business is operated out of the home 105. The service provider system may collect home maintenance data about the home 105 such as, for example, maintenance logs of operations performed on the home 105 (e.g., service calls, property damage and fixes, routine device maintenance, cleanings, bug or pest service, lawn or garden service, roofing replacement, or the like), equipment installations and removals, device warranty information, or home improvements (e.g., new deck, pool, room(s), interior or exterior painting or weather proofing, solar installation, water reclamation systems installation, room remodeling, or the like).

The service provider system may collect home configuration data about the home 105 such as, for example, whether GFCI outlets or LED lights are installed in the home 105, whether power strips supporting multiple devices are in use, whether the home 105 has exercise equipment, types of grills or fryers installed in the home 105, whether the home 105 includes particular safety equipment (e.g., smoke or carbon monoxide detectors, fire extinguishers, deadbolts on exterior doors, water sensors, sump pump, or the like), paint colors used on various walls of the home 105.

In some embodiments, the service provider may be the operator of the HMM server 140 and the homeowner may provide such data via an input interface (e.g., online questionnaire, user interface, service application, or the like, during participation in the home health system described herein). Collection and use of such data may be opted into by the homeowner on behalf of the occupants. In some embodiments, the system 100 may query the homeowner for any data elements described herein and not otherwise automatically accessed by the system 100.

In the exemplary embodiment, the system 100 may access aerial data of the home 105, such as satellite-, aerial-, or drone-captured overhead images of the home 105 and surrounding property. Such aerial data may be used to determine various externally visible features of home data (e.g., via digital image processing, machine learning, or human analysis). For example, the system 100 may use aerial data to determine structural elements of the home 105 or surrounding property, such as whether the home 105 has a swimming pool, a fence, or a deck, how many garages the home 105 has, or the like.

The system 100 may use aerial data to determine whether the home 105 has trees nearby (e.g., which may cause damage to the home 105 or drop leaves onto the roof of the home 105) or whether the home 105 is located on a cul-de-sac or a busy road. Such aerial data may be provided by a third party or public external data source (e.g., United States Geological Survey (“USGS”), National Aeronautics and Space Administration (“NASA”), NOAA, Google®, or the like) or may be privately collected (e.g., via aerial or drone photography of the home 105 by the insurance provider, realtor, or the like). Such aerial data may include global positioning system (“GPS”) location data for the home 105.

The system 100 may train a model of satellite images of homes 105 with labeled data of the homes 105 indicating, for example, whether the homes 105 have pools, decks, nearby trees, or other such features. As such, the trained model may be configured to automatically evaluate an unlabeled home (e.g., the home 105 in FIG. 1) to determine whether such features are present or otherwise categorize the home 105 with respect to those features.

In some embodiments, the system 100 may access mapping data around the home 105 to determine various home features. The system 100 may utilize a web mapping service (e.g., Google® Maps or the like) as an external data source. For example, the system 100 may access the web mapping service via an application programming interface (“API”) that allows the system 100 to submit, for example, the postal address of the home 105 or a GPS coordinate of the home 105 and query the web mapping service to provide features such as distances to nearby services (e.g., distance to nearest hospital, fire department, police station, schools, places of worship, parks, grocery stores, to various types of entertainment or other amenities, or the like). Mapping data may be used to determine whether the home 105 is situated on a busy or isolated road.

The mapping data may include ground-level imagery provided by the web mapping service that may be used by the system 100 to evaluate various externally visible features of home data (e.g., via digital image processing, machine learning, or human analysis). For example, the system 100 may use ground-level imagery to determine structural features of the home 105 such as a number of stories of the home, type of windows installed in the home, a roof type or type of exterior of the home, or how many garages the home has. The system 100 may train a model of ground-level images of homes 105 with labeled data of the homes 105 indicating, for example, how many stories or garages the homes 105 have, what type of exterior or roof type the homes 105 have, or other such features. As such, the trained model may be configured to automatically evaluate an unlabeled home (e.g., the home 105 in FIG. 1) to determine whether such features are present or otherwise categorize the home 105 with respect to those features.

### Exemplary Computer-Implemented Method for Monitoring For Maintenence Tasks

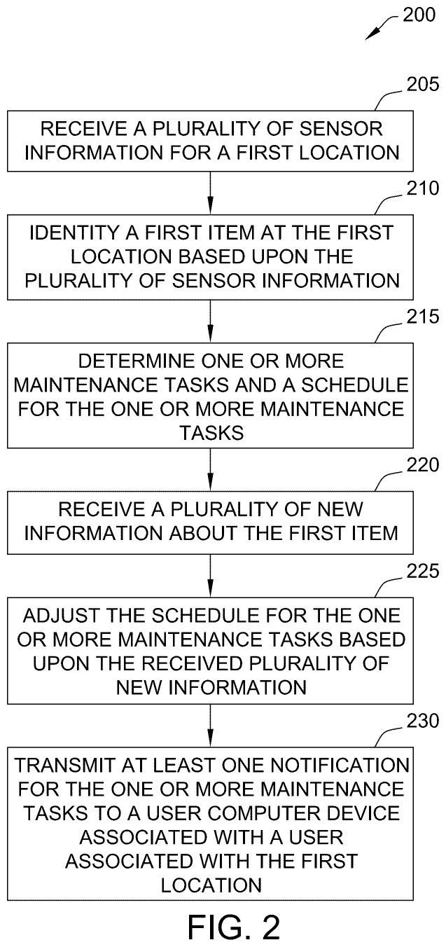

FIG. 2 depicts a flow chart of an exemplary computer-implemented process 200 for monitoring and analyzing property using the system 100 (shown in FIG. 1). Process 200 may be implemented by a computing device, for example home maintenance monitoring (“HMM”) server 140 (shown in FIG. 1). In the exemplary embodiment, HMA server 140 may be in communication with one or more items 110 installed within a home 105, one or more sensors 130, one or more user computer devices 135, one or more home controllers 145 (all shown in FIG. 1), and/or one or more third-party servers 405 (shown in FIG. 4).

In one exemplary embodiment, a home maintenance monitoring (HMM) system 100 and server 140 monitor different sensors 130 in a home 105 (or other location) to detect when different items 110 are used in the home 105 and uses that information to determine modifications to any maintenance schedules for the items 110. In some embodiments, the HMM system 100 and server 140 calculates a usage score or severity score for the condition of the corresponding items 110 and uses that score to determine when maintenance should occur. Furthermore, in some embodiments, the HMM system 100 and server 140 may use usage time and/or weather data to determine the score.

In the exemplary embodiment, items (and/or devices) that may need maintenance tasks to be performed include, but are not limited to, HVAC (heating, ventilation, and air conditioning), appliances, solar panels, garage door openers, security systems, garbage disposals, outdoor or indoor pools, roofs, gutters, IoT (Internet of Things) devices, etc.

In the exemplary embodiment, the HMM server 140 receives 205 a plurality of sensor information for a first location 105 (shown in FIG. 1).

In the exemplary embodiment, the HMM server 140 identifies 210 a first item 110 at the first location 105 based upon the plurality of sensor information. In the example embodiment, the HMM server 140 identified 210 which items 110 are in the home 105 based upon listening to the noises in the home 105 to identify the items 110 in the home 105. The HMM server 140 may use microphones on smart user computer devices 135, such as smartphones, home controllers 145, items 110 with verbal interaction capabilities, etc. The HMM server 140 may also use images of the home 105 and perform image recognition to identify items 110.

In other embodiments, the HMM server 140 uses one or more sensors 130 to perform a LIDAR (Light Detection and Ranging) scan of the home 105 to identify the items 110. In further embodiments, the HMM server 140 communicates with a wireless or wired network in the home 105 to identify the items 110 connected to the network. In still further embodiments, the HMM server 140 uses electricity monitoring systems to determine which items 110 are in the home 105 and the usage of those items 110. In additional embodiments, the HMM server 140 identifies 210 a plurality of items 110 at the first location 105.

In some further embodiments, the HMM server 140 uses artificial intelligence/machine learning (AI/ML) tools to identify the items 110 in the home 105. In these embodiments, the AI/ML tools have been trained to identify items 110 based upon noises, images, electricity usage patterns, LIDAR imaging, etc. In some of these embodiments, the HMM server 140 generates a model of the home 105 and the items 110 in the home 105. In these embodiments, the HMM server 140 may also use the AI/ML tools to determine the condition of the identified items 110 and/or identify when maintenance tasks are needed.

In the exemplary embodiment, the HMM server 140 determines 215 one or more maintenance tasks and a schedule for the one or more maintenance tasks for the first item 110. In the exemplary embodiment, the HMM server 140 maintains a calendar of maintenance tasks for a home 105. The maintenance tasks may include tasks that need to be performed on a periodic basis, such as but not limited to, replacing air filters, cleaning gutters, having different appliances serviced, etc.

In the exemplary embodiment, the HMM server 140 receives 220 a plurality of new information about the first item 110. The HMM system server 140 may collect some home data from external sources (e.g., publicly available data, such as historical weather-related information or power outage statistics for the area, emergency service response statistics for the area, or the like) or from home sources (e.g., data gathered from sensors, appliances, IoT devices, or networked devices within and/or around the house). The homeowner/user may also provide the HMM server with access to data from different sensors 130 and other items 110 in the home, such as Internet of Things (IoT) devices. The IoT devices may provide their data directly and/or provide data through servers associated with and in communication with the IoT devices.

The HMM server 140 may then analyze the provided data to, for example, alert appropriate or registered users of various projected or current risks to the home 105 and maintenance tasks to mitigate those risks. As such, subject homes 105 may include a home controller 145 that is configured (e.g., on a home network) to communicate with various sensors 130, appliances, structures, devices, and other items 110 within the home 105 and to relay home data to a remote system server (such as HMM server 140) for various uses discussed herein.

In the exemplary embodiment, the HMM server 140 adjusts 225 the schedule for the one or more maintenance tasks based upon the received plurality of new information. Then the HMM server 140 determines an amount of usage for the corresponding items 110 and makes modifications to the dates for the tasks based upon how the amount of usage would necessitate sooner maintenance.

In the exemplary embodiment, the HMM server 140 transmits 230 at least one notification for the one or more maintenance tasks to a user computer device 135 associated with a user associated with the first location 105. In the exemplary embodiment, the HMM server 140 transmits 230 notifications about upcoming and needed maintenance tasks to one or more user computer devices 135 associated with the user/homeowner. In some further embodiments, the HMM server 140 may provide links to phone numbers, websites, email addresses, etc. of service providers to assist the user/homeowner in performing the maintenance tasks. For example, if it is time to clean the gutters, then the HMM server 140 may provide the contact information for the service provider that cleaned the gutters previously. The HMM server 140 may also provide the contact information for a service provider that is offering a special or savings on performing that maintenance task.

The HMA server 140 may also be in communication with one or more marketplaces that provide access to and matching with companies that provide maintenance services to perform needed maintenance tasks for the home 105. Other examples of products and/or services provided by the marketplace include, but are not limited to, plumbers, smart home devices, security systems, maintenance, such as of a HVAC (heating, ventilation, and air conditioning) system, and/or insurance.

In some further embodiment, the plurality of sensor information includes noise information captured by a microphone at the first location. The microphone is a part of a mobile computer device, such as user computer device 135. In other embodiments, the plurality of sensor information includes one or more images of the first location 105 or LIDAR (light detection and ranging) imaging. In still further embodiments, the plurality of sensor information includes information about one or more items 110 connected to a home wireless network.

In some embodiments, the plurality of new information includes at least one of usage information of the first item 110 and environmental information for at least one of the first item 110 and the first location 105. The plurality of new information may include audio of the first item 110 in operation. The plurality of new information may also include weather information.

In further embodiments, the least one notification includes a video on how to perform the one or more maintenance tasks.

In some further embodiments, the HMM server 140 generates a model using a plurality of historical data, a plurality of operational data of a plurality of related items, a plurality of historical maintenance data of the plurality of related items, and a plurality of historical performance data of the plurality of related items. The HMM server 140 trains the model to identify operational trends for items. These operational trends may be indicative of a need for maintenance tasks to be performed on the corresponding item. For example, the HMM server 140 inputs current operational data and maintenance data for a candidate washing machine into the model. The model compares the actual performance data of the washing machine to that of the model washing machine. Based on the comparison, the model updates the maintenance schedule of the candidate washing machine.

While various examples provided herein describe application of the HMM system to various aspects of homes, the systems and methods described herein may also be used for performing other analysis, such as vehicles, businesses, municipal locations, and/or other locations and/or items.

### Exemplary Source Devices

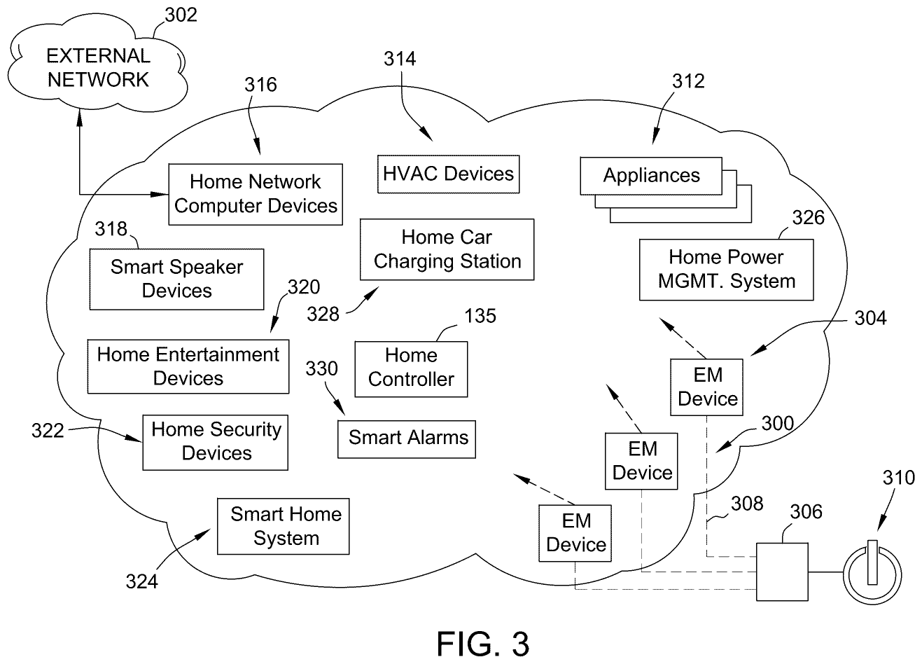

FIG. 3 illustrates exemplary source devices that may be used with the HMM system 100 (shown in FIG. 1). In the exemplary embodiment, the home controller 145 (shown in FIG. 1) is in communication with or otherwise monitors or collects data from or about a variety of items 110 (shown in FIG. 1) within the home network. The home 105 (shown in FIG. 1), and the various items 110 therein, may be powered by an electrical distribution system 300. Paths of electrical power flow are illustrated in FIG. 3 in broken lines. The electrical distribution system 300 includes multiple electrical circuits 308, each of which may provide power to one or more of the items 110 or other electrical devices within the home 105. Each of the example circuits 308 emanate from an electrical distribution panel 306 that receives power from a power source 310, such as a utility power company or an on-premises power source (e.g., gas generator, solar generator, wind generator). Each circuit 308 may include a circuit breaker for each circuit 308 in the electrical distribution panel 306. While not expressly shown, any of the various items 110 may be connected to and powered by the electrical circuits 308.

In the exemplary embodiment, the system 100 may include one or more electricity monitoring (“EM”) devices 304. EM devices 304 may be used to monitor electricity flowing to individual electric devices, such as smart devices or appliances, electronics, vehicles, or mobile devices, and may be configured to monitor or detect abnormal usage or trends. Abnormal electricity flow (“EF”) to various devices may indicate that failure is imminent, maintenance or device replacement is needed, de-energization is recommended, or other corrective actions are prudent. For example, the EM devices 304 may be TING® smart sensors such as those made commercially available by Whisker Labs of Germantown, MD.

EF data collected by the EM devices 304 may include data indicative of electricity flow to or from various smart or other electronic devices, including the various devices shown here in FIG. 3. EF data may also include electricity or energy usage for each electronic component, device, outlet, circuit, or the like, within the home 105, such as data indicating the electricity each device or room is using. For example, energy usage of air conditioners, washers, dryers, dish washers, refrigerators, stoves, ovens, microwave ovens, televisions, lamps, outlets, computers, laptops, mobile devices, other electronic devices, may be determined by the EM device 304. EF data may be used to detect hazards or other abnormalities that may indicate a risk to the home 105 or its assets.

EM devices 304 may include sensors that are configured to monitor and collect EF data. EM devices 304 may be plugged into electrical outlets within the home (e.g., conventional 110-volt outlets) for at least powering the EM device 304 and/or items 110 or may be electrically wired into a circuit 308 for powering the EM device 304 and/or items 110. Further, some EM devices 304 may collect EF data directly from a circuit 308 (e.g., via wired connection to the circuit 308, referred to herein as “direct sensing”) and some EM devices 304 may wirelessly collect EF data from circuits 308, appliances, or other electricity consuming devices (referred to herein as “wireless sensing”). Wireless sensing may include, for example, sensors within the EM device 304 that are configured to sense electromagnetic waves or an electrical signature of the electrical devices receiving power from the electrical distribution system 300.

The EM devices 304 may directly or wirelessly detect each flow of electricity to or from each different electronic device by identifying each electronic device by its unique electronic or electrical signature (or “fingerprint”). The EM devices 304 may then generate electricity usage or flow data for each electronic device within the home or connected to the electrical distribution system 300 (such as a hybrid or fully electric vehicle having its battery directly or wirelessly charged by the home's electrical system). In some embodiments, EM devices 304 may be positioned in vicinity of the electrical distribution panel 306 and may capture electrical activity about the home 105 by wirelessly detecting an electricity flow to devices that are coupled to the electrical distribution board 306.

In other embodiments, EM devices 304 may be positioned in vicinity of the electrical distribution panel 306, but not hardwired to the electrical distribution panel 306 or home electrical wiring system, and may capture electrical activity about the home 105 by wirelessly detecting an electricity flow to devices that are coupled to the electrical distribution board 306. In other embodiments, EM devices 304 may be plugged into electrical outlets positioned throughout a home.

During operation, as one or more of the electric devices receives electricity via the electrical distribution system 300, each device may be differentiated by an electrical signature that is unique to a respective device (such as by one or more EM devices 304 monitoring, detecting, and/or analyzing the electricity flowing to or being consumed by each respective electric device, and/or by monitoring EF data generated or collected by one or more EM devices 304).

In other words, transmission of electricity to a refrigerator, for example, may be differentiated from transmission of electricity to an electric stove (such as via one or more EM devices 304 and/or analyzing the EF data generated or collected by one or more EM devices 304). Furthermore, transmission of electricity to a television on one circuit 308 or outlet, for example, may be differentiated from transmission of electricity to another recipient electric device (e.g., a cable television box) via the same circuit 308 or electrical outlet. The system 100 may correlate electrical activity with a variety of electric devices on the electrical distribution system 300 based upon electrical signatures unique to each respective device. The system 100 may build a structural electrical profile for the home 105, which may include data indicative of operation of the various electric devices within or around the home 105 (e.g., over a period of time), such as by using EF data generated or collected by one or more EM devices 304 over a period of time.

In some embodiments, an EM device 304 may be affixed to or situated near the electrical distribution panel 306. Generally, the EM device 304 may utilize the unique, differentiable electrical signatures of the electric devices by directly or wirelessly monitoring electrical activity including transmission of electricity via the electrical distribution panel 306 to one or more of the electric devices. Monitoring of transmission of electricity to an electric device receiving the electricity may include, for example, monitoring (i) the time at which the electricity was transmitted, (ii) the duration for which the electricity was transmitted, and/or (iii) the magnitude of the electric current in the transmission.

Based upon the unique electrical signatures of the various electric devices of the home 105, the monitored electrical activity may be correlated with respective electric devices receiving the electricity transmitted via the electrical distribution system 300. Further, electrical activity associated with other components of the electrical distribution system 300 (e.g., the electrical distribution panel 306, the circuits 308, or the like) may be correlated with one or more electric devices to which the electrical activity also pertains.

In some embodiments, the EM device(s) 304 may perform the correlation or other functions described herein, via one or more processors of the EM device(s) 304 that may execute instructions stored at one or more computer memories of the EM devices 304. In other embodiments, the EM devices 304 may collect the EF data, and the correlation and/or other functions described herein may be performed at another system (e.g., the home controller 145 or the HMM server 140), which may receive data or signals indicative of monitored electricity or other data via one or more processors or through transfer via a physical medium (e.g., a USB drive). Correlation of the electrical activity with the respective electrical devices may produce data indicating, for example, the time, duration, and/or magnitude of electricity consumption by each of the electric devices during a period of electrical activity monitoring.

Based upon at least the correlated electrical activity, a structure electrical profile may be built and stored at the EM devices 304 or at some other system (e.g., the home controller 145). The structure electrical profile may include, for each of the electric devices about the home 105, data indicative of operation of the respective electric device during at least the period at which the EM devices 304 monitored electrical activity about the home 105. Based upon the correlated electrical activity, the structure electrical profile may depict, for example, average electricity operation/usage, baseline electricity operation/usage, and/or expected electricity operation/usage/consumption. In effect, the structure electrical profile, based upon real electrical activity about the structure, may set forth what is “normal” operation and usage of electricity about the structure.

Thus, once the structure electrical profile is built, any electrical activity monitored via the home controller 145 and the EM device(s) 304 may be analyzed to determine whether electrical activity is abnormal. In response to the abnormal electrical activity, among other possible factors, corrective actions mitigate damage, prevent damage, and/or remedy the cause of the abnormal electrical activity the situation may be determined and/or initiated. Some possible corrective actions are discussed herein.

EF data regarding an electric device may include, for example, historical data indicating the electric device's past operation patterns or trends. For example, historical data may indicate a time of day, day of the week, time of the month, etc., at which an electric device frequently uses electricity (e.g., a lighting fixture may not use electricity during late night hours of the day). As another example, historical data may include the electric device's total electricity consumption or usage rate over a period of time. Additionally or alternatively, historical data may include data indicating past events regarding the electric device (e.g., breakdowns, power losses, arc faults, etc.). Additionally or alternatively, operation data regarding an electric device may include an expected electricity consumption or baseline electricity consumption for the electric device. For example, in the case of a refrigerator, the refrigerator's electricity consumption during a first period of monitoring may be reliably used to approximate an expected electricity consumption at a later time.

Further, the structure electrical profile may include data pertaining to the structure as a whole. For example, the structure electrical profile may include data reflecting a total electricity or average usage rate over a period of time. As another example, the profile may include time-of-day, day-of-week, etc., data reflecting times at which the home 105 as a whole uses more or less electricity. Further, the profile may detail specific types, classes, or specifications of electric devices that behave differently or consume a different amount of electricity compared to other electric devices within the home 105. Moreover, the profile may detail specific risks determined to be relevant to one or more of the electric devices or to the home 105 as a whole, based upon the electrical activity of the electric devices.

Furthermore, the structure electrical profile may include a digital “map” of the home 105. A home map may indicate spatial locations of the electric devices, and/or spatial relationships between two or more of the electric devices. Such mapping may indicate, for example, a risk associated with the spatial placement of a stove, and/or a risk associated with placing a refrigerator adjacent to the stove. Additionally or alternatively, the home map may indicate which of the electric devices are connected to each electrical circuit 308 within the electrical distribution system 300 of the home 105. Such mapping may indicate, for example, a risk of overloading a particular circuit 308 based upon a number or intensity of electric devices connected to the circuit 308. As another example, the home map may be used to determine what electric devices may lose power if a particular circuit 308 were to be de-energized (e.g., due to risk or abnormal electrical activity associated with one electric device on the circuit).

In some embodiments, the home map may be configurable by a user (e.g., the homeowner of the home 105). The user may, for example, configure the map via an I/O module (e.g., screen, keypad, mouse, voice control, etc.) of the home controller 145, or via an I/O module of another computing device, which may transmit the home map to the home controller 145. Additionally or alternatively, the home map may be stored at one or more computer memories of another system (e.g., HMA server 140).

In some embodiments, the home network 302 may include a home power management system 326. The home power management system 326, or the controller 145 in conjunction with the EM devices 304, may collect power consumption data on the circuits 308 (e.g., via EM devices 304) or device electrical usage data of various electronic devices within the home 105. The home power management system 326 may, for example, collect usage data for lights or appliances within the home 105, giving an indication of how much electricity the home 105 uses or how frequently occupants are at home. In some embodiments, the home 105 may include one or more smart plugs (not separately shown) which may be managed by the power management system 326, the smart speaker device 318, the smart home system 324, or otherwise by the system 100 (e.g., for activating or deactivating devices plugged into the circuits 308 via the smart plugs, such as via 110-volt outlets).

The home power management system 326 may identify and provide details on what appliances or other consuming devices are within the home 105 (e.g., manufacturer make and model), thereby allowing the system 100 to identify some property on the premises (e.g., device identification and verification, device count), evaluate value of devices (e.g., replacement costs), or collect manufacturer-provided or consumer protection-provided details regarding the devices from external data sources (e.g., susceptibility of the device to power surges, likelihood of fire caused by the device, mean time to failure of the device, types of device failures, power consumption profiles and tolerances of the device, or the like).

The home power management system 326 may collect power quality data for the home 105, such as occurrences and frequency of power outages or reductions in service (e.g., black-outs or brown-outs), loading at various times throughout the day or week, the size of service, occurrences of voltage values fluctuating beyond tolerance ranges (e.g., spikes), or the like. In some embodiments, the home power management system 326 may include one or more smart circuit breakers (e.g., on any or all of the circuits 308) or a smart panel (e.g., as the electrical distribution panel 306), such as those made commercially available by Schneider Electric (Paris, France), which may provide circuit-level data and operations such as, for example, current or historical circuit load data, circuit breaker status, or turning circuit breakers on or off. Such power data may be used to construct a power profile for the home 105. In some embodiments, the home controller 145 may perform any such power monitoring and data collection operations in lieu of, or in addition to, the home power management system 326.

In the exemplary embodiment, the home 105 may include one or more smart appliances 312 (e.g., appliances that can communicate via the home network 302, which may include devices). Smart appliances 312 may include, for example, dish washers, microwaves, stove tops, ovens, grills, clothes washers and dryers, water heaters, water meters, water softeners or purifiers, smart lighting, smart window blinds or shutters, piping, interior or yard sprinklers, or the like. The home controller 145 may be configured to communicate with such smart appliances 312 and may collect home data from such appliances for the system 100.

For example, the appliances 312 may provide data such as device data (e.g., manufacturer, make, model, date of manufacturer, date of installation, software or firmware versions), usage data (e.g., daily usage time, power consumption), or log data (e.g., log events, alerts, component failure detections, maintenance history, or the like). Such appliance data may allow the system 100 to detect which appliances are present in the home 105 (broadly, as a part of an “asset inventory” of the house), their replacement value, age of each appliance, a maintenance history of each appliance, to detect when appliances or their components are failing.

The system 300 may use such data, for example, to construct the power profile for the home 105, to compute the safety score for the home 105, to compute in an insurance profile for the home (e.g., as factors of risk to lightning or other hazards), or to alert the homeowners when an appliance registers a failure.

In the exemplary embodiment, the home 105 may also include smart HVAC devices such as, for example, a heater (e.g., a gas or electric furnace), an air conditioner, an air purifier, an attic fan, a ceiling fan. Some or all such devices may be controlled by a thermostat device. Such devices are collectively referred to herein as HVAC devices 314, some of which may not be smart devices but may nonetheless be controlled in some respects by the thermostat device.

The system 100 may collect HVAC data such as device data (e.g., manufacturer, make, model, date of manufacturer, date of installation), usage data (e.g., daily usage time, power consumption), or thermostat data (e.g., temperature settings, daily schedule profiles). The system 100 may use such data, for example, to construct the power profile for the home 105, to compute the safety score for the home 105 (e.g., determining how often the home 105 is typically occupied), to compute in an insurance profile for the home (e.g., as factors of risk to lightning or other hazards, likelihood of equipment failures), or to alert the homeowners when an HVAC device registers a failure.

The home 105, in the exemplary embodiment, may also include various computing devices such as, for example, desktop or laptop personal computers, tablet computers, servers, or networking devices (e.g., Wi-Fi routers, switches, hubs, firewalls, or the like), all of which are collectively represented here as home network/computer devices (or just “computer devices”) 316. The networking devices may provide some or all of the home network 302 that is used to facilitate communication between the devices shown here.

The home controller 145 may be configured to capture computer device data from some or all of these computer devices 316 such as, for example, a number and type of computing devices (e.g., hardware manufacturer, make, model, and the like), hardware and software profile of computing devices, configuration data of computing devices (e.g., software versions, firmware versions), usage data, and log data (e.g., firewall logs, access logs, software patch logs, error logs). The system 100 may use such data to, for example, determine asset inventory and valuation, construct the power profile for the home 105 (e.g., average daily usage), alert the homeowners when devices need software or firmware upgrades (e.g., critical security alerts) or upon intrusion detection or other compromise of computer devices 316 (e.g., software hacks).

In the exemplary embodiment, the home 105 may include a smart speaker device(s) (or “nest device”) 318 that may interact with occupants of the home 105 (e.g., via audible commands and responses, digital display, executing pre-configured actions). Some example smart speaker devices 318 include the Echo® devices (Amazon Inc., of Seattle, Washington) and the Google Nest® devices (Alphabet Inc., of Mountain View, California), to name but a few. The smart speaker device 318 may include a speaker for providing audio output, a microphone for receiving audio input (e.g., commands spoken by the occupants), and may include a display device for video output or a camera device for capturing video input. The smart speaker device 318 may be configured to interact with other smart devices, such as for controlling lighting within the home 105, the thermostat (e.g., changing thermostat settings), home security devices of a home security system 320 (e.g., locking and unlocking smart locks on doors, opening or closing garage doors, or the like), or entertainment devices of a home entertainment system 326 (e.g., enabling, disabling, or reconfiguring music or television devices).

The system 100 may, with owner configuration and permission, utilize inputs from the smart speaker device 318 to, for example, determine a number of unique occupants of the home 105 (e.g., via unique speech profile or video identification), determine the number of children in the home 105 (e.g., via audio or video analysis), determine when occupants of the home 105 are currently or historically present (e.g., via noise detection, video movement), determine when other devices are turned on or off, determine presence of pets (e.g., via unique audio sounds or video identification of the pets), or smoke or carbon monoxide alarm detection (e.g., via audible sound). Such raw data may be sanitized or distilled by the home controller 145 into refined data before sending to the HMA server 140 in an effort to protect privacy of the home occupants while still providing home health evaluation and risk capabilities (e.g., sending results determined from the raw audio or video data and deleting the raw audio or video data). The system 100 may anonymize personal data, thereby allowing data to be stored or used without direct attribution of data to a particular homeowner.

In the exemplary embodiment, the home 105 may include various home entertainment devices 320 such as, for example, televisions, digital video recorders (“DVR”), radios, amplifiers, speakers, remotes, or console gaming systems, any or all of which may be smart devices in communication with the home network 302 and the controller 145. The controller 145 may collect home entertainment data from such devices and may use that data, for example, to construct the power profile for the home 105, to construct the asset inventory of the home 105, to compute the safety score for the home 105, to compute in an insurance profile for the home (e.g., as factors of risk to lightning or other hazards, likelihood of equipment failures).

The home 105, in the exemplary embodiment, may include a home security system 322. The home security system 322 may include security devices such as, for example, door or window sensors (e.g., to detect when doors or windows or open, when windows are broken), motion sensors (e.g., to detect when someone is present within range of the sensor), security cameras (e.g., for capturing audio/video of particular areas in or around the home 105, such as a doorbell camera), key pads (e.g., for enabling/disabling the security system), panic buttons (e.g., for alerting a security service or authorities of an emergency situation), security hubs (e.g., for integrating individual security devices into a security system, for centrally controlling such devices, for interacting with third parties), electric door locks, or smoke/fire/carbon monoxide detectors. Such “security devices” broadly represent devices that can detect potential contemporaneous risks to the home 105 or its occupants (e.g., intrusion, fire, health).

The home security system 322 may be configured to communicate with a third-party security service or local authorities, and may transmit alerts to such parties when events are detected. The home controller 145 may be configured to receive alert data from the home security system 322 and may transmit such alerts to the HMM server 140, create historical logs of security events, or transmit alert events directly to the homeowner (e.g., via SMS text message or the like) or to local authorities, fire protection, or emergency services. The system 100 may use such security alert events to, for example, determine how frequently security events occur (e.g., as a factor for risk), how often such events are warranted (e.g., authentic risks rather than false alarms), or the type and nature of such authentic risks or false alarms.

The system 100 may use raw data collected directly from any of these security devices. For example, the home controller 145 may use raw data from the motion sensors to detect when the home 105 is occupied (e.g., to build a profile of occupancy times), may use raw data from the camera devices or door devices to detect when occupants enter or exit the home 105, may use the camera devices to determine a number of occupants of the home 105 or a number and type of pets in the home 105. The home controller 145 may determine information about the home security system 322 installed within the home, such as a number and type of security sensors installed within the home 105, a type of home security system 322 installed in the home (e.g., third-party service provider, device manufacturers, types of security protection implemented within the home), or how often the homeowners leave the home 105 unoccupied without activating the home security system 322 (e.g., as a factor in risk calculations or home health scoring). The system 100 may rate the home security system 322 and associated devices and services to generate a home security protection rating (e.g., relative to other available security systems or hardware) and may use that rating as a factor in risk calculations or in preparing a risk mitigation proposal (e.g., for more or better devices or security systems).

In some embodiments, the home 105 may include a smart home system 324 (e.g., a home monitoring system) that allows the homeowner and occupants to control various devices within the home 105. For example, the smart home system 324 may be configured to control, inter alia, devices such as the smart appliances 312, HVAC devices 314, home entertainment devices 320, or home security system 322.

In the exemplary embodiment, the home controller 145 may be configured to interact directly with such devices as described herein (“direct access”) or may be configured to perform some interactions and data collections with such devices through the smart home system 324 (“proxy access”). For example, any or all of the data collections or operations described herein may be performed by the smart home system 324 based upon commands received from the home controller 145, thereby allowing the system 100 to perform such operations through the smart home system 324 acting as a proxy for some such operations.

In the exemplary embodiment, the home 105 may include a home car charging station 328 that may be used to recharge electric vehicles (not shown). The home car charging station 328 may draw power from one or more of the circuits 308 of the electrical distribution system 300 and may include an on-premises power source (e.g., solar panels, wind generator, or the like) or a dedicated battery bank (e.g., for storing excess power from the local energy source). The system 100 may capture various charging station data from the home car charging station 328, from the circuits 308 used for the charging station 328, or from the local power source device(s).

In the exemplary embodiment, the home 105 may include one or more smart alarms 330 that are configured to detect various conditions within the home 105 and may alert the homeowner or other occupants (e.g., via audible alarm, SMS text message, email, or the like). Smart alarms 330 may include, for example, smoke detectors, carbon monoxide detectors, carbon dioxide detectors, or indoor air quality (“IAQ”) monitors or systems that include sensors configured to, for example, detect dangerous conditions such as fire or buildup of carbon monoxide, the presence of dangerous pollutants such as radon or various volatile organic compounds (“VOC”), or collect various air quality data such as temperature and humidity.

Smart alarms 330 may include water leak detectors or flood alarms that may be configured to detect the presence of water at various areas in the home 105, such as near HVAC equipment, water tanks, sump pumps, below showers or bathtubs, around basement perimeters, behind or within basement walls, or the like. Such water detectors may identify leaks within plumbing or appliances within the home 105 or ingress of water into the home 105 (e.g., rainwater, flooding, failing sump pump, foundation cracks, or the like). The system 100 may collect alarm data from the smart alarms 330 and may perform automatic alerting based upon sensor events registered at such smart alarms 330 (e.g., alerting emergency services, homeowner, or the like, in an effort to protect life and property, mitigate damage, or such) or initiate automatic actions (e.g., shutting off water flow within the home 105, or within a particular segment of plumbing, via activating a smart water shut off valve, not separately shown).

The system 100 may identify the presence of such smart alarms 330 or shut off valves in the home 105 when configured to communicate with the smart alarms 330 and may automatically provide policy discounts when particular smart alarms 330 are detected as present or may include the presence or absence of such smart alarms 330 in the various aspects of home health scoring. Furthermore, the HMM server 140 may be configured to provide marketplace suggestions of providers to assist with the issues that are associated with the alarms.

### Exemplary Computer System

FIG. 4 illustrates an exemplary computer system 400 for implementing the home maintenance monitoring (HMM) system 100 (shown in FIG. 1) performing the process 200 (shown in FIG. 2). In the example embodiment, the system 400 is used for analyzing sensor data and external data associated with a home 105 (shown in FIG. 1) to detect maintenance issues with that home 105 and to propose maintenance actions to mitigate those issues.

As described below in more detail, the HMM server 140 is programmed to analyze sensor data and external data associated with a home 105 to detect maintenance issues with that home 105 and to propose maintenance actions to mitigate those issues. The HMM server 140 is programmed to (1) receiving, by the one or more processors, a plurality of sensor information for a first location; (2) identifying, by the one or more processors, a first item 110 (shown in FIG. 1) at the first location based upon the plurality of sensor information; (3) determining, by the one or more processors, one or more maintenance tasks and a schedule for the one or more maintenance tasks for the first item 110; (4) receiving, by the one or more processors, a plurality of new information about the item device 110; (5) adjusting, by the one or more processors, the schedule for the one or more maintenance tasks based upon the received plurality of new information; and/or (5) transmitting, by the one or more processors, at least one notification for the one or more maintenance tasks to a user computer device 135 associated with a user associated with the first location 105.

In the exemplary embodiment, sensors 130 may be computers that include a web browser or a software application, which enables sensors 130 to communicate with HMM server 140 using the Internet, a local area network (LAN), or a wide area network (WAN). In some embodiments, the sensors 130 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Sensors 130 may be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contacts, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices. In the exemplary embodiment, sensors 130 are devices connected to the home network 302 (shown in FIG. 3) that provide information about the home 105.

In the example embodiment, user computer devices 135 are computers that include a web browser or a software application, which enables user computer devices 135 to communicate with HMM server 140 using the Internet, a local area network (LAN), or a wide area network (WAN). In some embodiments, the user computer devices 135 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User computer devices 135 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contact lenses, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, the HMM server 140 (also known as HMM computer device 140) is a computer that includes a web browser or a software application, which enables HMM server 140 to communicate with user computer devices 135 using the Internet, a local area network (LAN), or a wide area network (WAN). In some embodiments, the HMM server 140 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The HMM server 140 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contacts, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, home controllers 145 are computers that include a web browser or a software application, which enables home controllers 145 to communicate with associated items 110 (shown in FIG. 1) and the HMM server 140 using the Internet, a local area network (LAN), or a wide area network (WAN). In some embodiments, the home controllers 145 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The home controllers 145 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contacts, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the exemplary embodiment, third-party servers 405 are computers that include a web browser or a software application, which enables third-party servers 405 to communicate with associated the HMM server 140 using the Internet, a local area network (LAN), or a wide area network (WAN). In some embodiments, the third-party servers 405 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The third-party servers 405 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, smart contacts, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 410 is communicatively coupled to a database 415 that stores data. In one embodiment, the database 715 is a database that includes device data, sensor data, weather data, and/or maintenance actions. In some embodiments, the database 415 is stored remotely from the HMM server 140. In various embodiments, the database 415 is decentralized. In the exemplary embodiment, a person may access the database 415 via the user computer devices 135 by logging onto HMM server 140.

### Exemplary Client Device

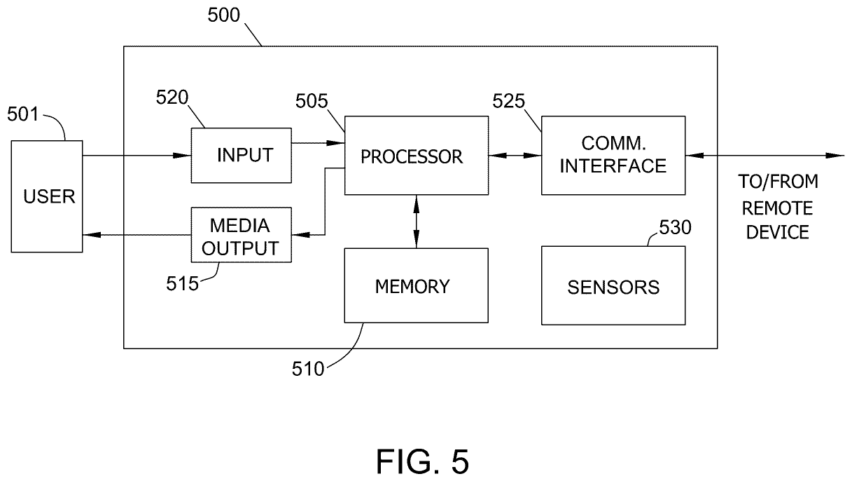

FIG. 5 depicts an exemplary configuration of a client computer device shown in FIGS. 1 and 4, in accordance with one embodiment of the present disclosure. User computer device 502 may be operated by a user 501. User computer device 502 may include, but is not limited to, items 110, dryer 115, HVAC 120, garbage disposal 125, sensors 130, user computer devices 135 (all shown in FIG. 1), EM devices 304, HVAC devices 314, home network computer devices 316, smart speaker devices 318, home entertainment devices 320, home security system 322, smart home system 324, home power management system 326, and home charging station 328 (all shown in FIG. 3).

User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display), an audio output device (e.g., a speaker or headphones), virtual headsets (e.g., AR (Augmented Reality), VR (Virtual Reality), or XR (extended Reality) headsets), and/or voice or chat bots.

In some embodiments, media output component 515 may be configured to present a graphical user interface (e.g., a web browser and/or a client application) to user 501. A graphical user interface may include, for example, an online score viewing interface for viewing a home health score and determining more information about the home health score. In some embodiments, user computer device 1002 may include an input device 520 for receiving input from user 501. User 501 may use input device 520 to, without limitation, select a provider.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as the HMM server 140 (shown in FIG. 1). Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from the HMM server 140. A client application allows user 501 to interact with, for example, the HMM server 140. For example, instructions may be stored by a cloud service, and the output of the execution of the instructions sent to the media output component 515.

Processor 505 executes computer-executable instructions for implementing aspects of the disclosure. In some embodiments, the processor 505 is transformed into a special purpose microprocessor by executing computer-executable instructions or by otherwise being programmed.

### Exemplary Server Device

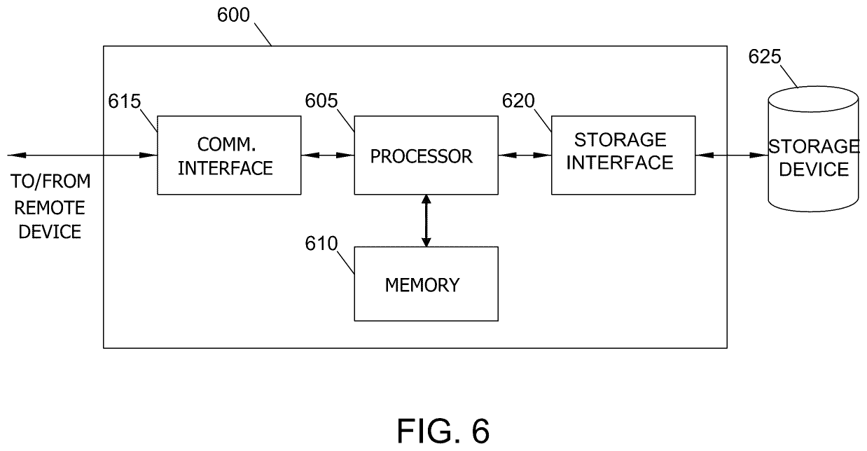

FIG. 6 depicts an exemplary configuration of a server 600, in accordance with one embodiment of the present disclosure. Server computer device 600 may include, but is not limited to, HMM 140, home controller 145 (both shown in FIG. 1), home security system 322, smart home system 324, home power management system 326, (all shown in FIG. 3), third-party server 405, and database server 415 (both shown in FIG. 4). Server computer device 600 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 600 is capable of communicating with a remote device such as another server computer device 600, third-party server 405, HMM server 140, or user computer devices 135 (shown in FIG. 1). For example, communication interface 615 may receive requests from user computer devices 135 via the Internet, as illustrated in FIG. 4.

Processor 605 may also be operatively coupled to a storage device 634. Storage device 634 may be any computer-operated hardware suitable for storing and/or retrieving data, such as, but not limited to, data associated with database 415 (shown in FIG. 4). In some embodiments, storage device 634 may be integrated in server computer device 601. For example, server computer device 600 may include one or more hard disk drives as storage device 634.

In other embodiments, storage device 634 may be external to server computer device 600 and may be accessed by a plurality of server computer devices 600. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 1134 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instructions such as illustrated in FIG. 2.

### Exemplary User Interface

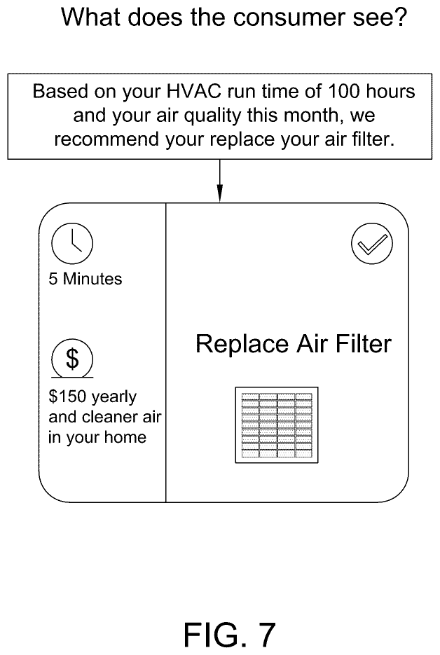

FIGS. 7-9 illustrate exemplary notifications for home maintenance tasks from the home maintenance monitoring (HMM) server 140 (shown in FIG. 1).

FIG. 7 illustrates an exemplary notification to the user/homeowner about a needed maintenance task of replacing the air filters for the HVAC system 120 (shown in FIG. 1). The notification includes a time to complete the task and potential benefits of performing the maintenance tasks. In some embodiments, the notification includes a link to a video on how to replace the air filters. The notification may also include a link to a retailer to purchase the needed air filters from.

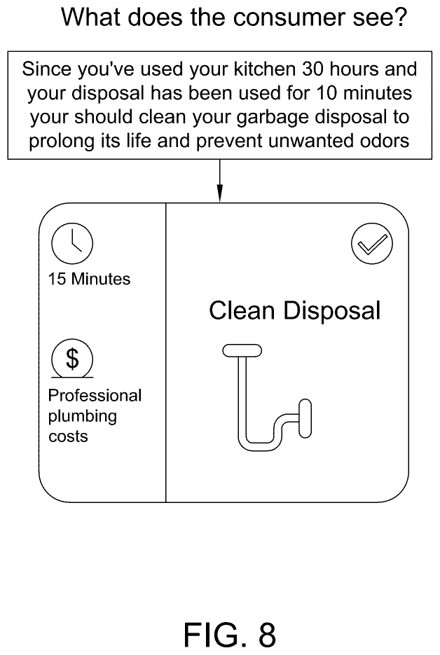

FIG. 8 illustrates an exemplary notification to the user/homeowner about a needed maintenance task of cleaning the garbage disposal 125 (shown in FIG. 1). The notification includes a time to complete the task and potential negative consequences of not performing the maintenance task. In some embodiments, the notification includes a link to a video on how to safely clean the garbage disposal 125. The notification may also include a link to a retailer to purchase any needed supplies and/or tools from.

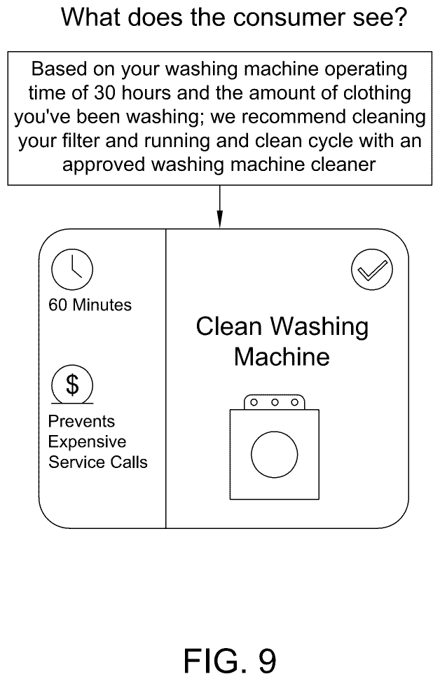

FIG. 9 illustrates an exemplary notification to the user/homeowner about a needed maintenance task of cleaning the washing machine. The notification includes a time to complete the task and potential negative consequences of not performing the maintenance task. In some embodiments, the notification includes a link to a video on how to safely clean the washing machine. The notification may also include a link to a retailer to purchase any needed supplies and/or tools from.

### Machine Learning and Other Matters

In some embodiments, HMM computer system 140 is configured to implement machine learning, such that HMM computer system 140 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of home attributes with known characteristics or features. Such information may include, for example, information associated with a plurality of items 110.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify appliances and other features of a home that may require maintenance.

### Exemplary Embodiments

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (i) receive a plurality of sensor information for a first location; (ii) identify a first item at the first location based upon the plurality of sensor information; (iii) determine one or more maintenance tasks and a schedule for the one or more maintenance tasks for the first item; (iv) receive a plurality of new information about the first item; (v) adjust the schedule for the one or more maintenance tasks based upon the received plurality of new information; and/or (vi) transmit at least one notification for the one or more maintenance tasks to a user computer device associated with a user associated with the first location. The system may have additional, less, or alternate functionality, including that discussed elsewhere herein.

An enhancement of the system may include a processor configured for smart home maintenance systems. The information may be, for instance, retrieved from one or more memory units and/or acquired via one or more sensors, including microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

A further enhancement of the system may include where the plurality of sensor information including noise information received by a first microphone at the first location and related to one or more items located near the first microphone. The system may also include where the first microphone is a part of a mobile computer device located at times within a home at the first location.

A further enhancement of the system may include where the plurality of sensor information including one or more digital images of the first location or LIDAR (light detection and ranging) images of the first location.

A further enhancement of the system may include where the plurality of sensor information including information about one or more intelligent devices connected to a home wireless network. The system may also include where the plurality of sensor information further includes information about one or more items connected to the one or more intelligent devices. The system may further include the one or more processors are programmed to identify a plurality of items at or near a home located at the first location, wherein the plurality of sensor information includes operational data of the one or more items.

A further enhancement of the system may include where the plurality of new information includes at least one of usage information of the first item and environmental information for at least one of the first item and the first location. The system may also include where the plurality of new information includes audio of the first item in operation. The system may also include where the plurality of new information includes weather information.

A further enhancement of the system may include where the at least one notification includes a video on how to perform the one or more maintenance tasks.

A further enhancement of the system may generate a model using a plurality of historical data, a plurality of operational data of a plurality of related items, a plurality of historical maintenance data of the plurality of related items, and a plurality of historical performance data of the plurality of related items. The system may also train the model to identify operational trends for items. The system may further include where the received plurality of new information includes operational data for the first item. The system may execute the model with operational data for the first item to adjust the schedule for the one or more maintenance tasks.

In yet another aspect, a computer-implemented method of evaluating and mitigating aspects of a residential property may be provided. The computer-implemented method may be performed by a computing device including at least one processor and/or associated transceiver. The method may include, via the at least one processor and/or associated transceiver: (i) receiving, by the one or more processors, a plurality of sensor information for a first location; (ii) identifying, by the one or more processors, a first item at the first location based upon the plurality of sensor information; (iii) determining, by the one or more processors, one or more maintenance tasks and a schedule for the one or more maintenance tasks for the first item; (iv) receiving, by the one or more processors, a plurality of new information about the first item; (v) adjusting, by the one or more processors, the schedule for the one or more maintenance tasks based upon the received plurality of new information; and/or (vi) transmitting, by the one or more processors, at least one notification for the one or more maintenance tasks to a user computer device associated with a user associated with the first location. The method may have additional, less, or alternate actions, including that discussed elsewhere herein.

An enhancement of the method may include smart home maintenance systems. The interactions may be, for instance, retrieved from one or more memory units and/or acquired via one or more sensors, including cameras, microphones, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

A further enhancement of the method may include where the plurality of sensor information including noise information received by a first microphone at the first location and related to one or more items located near the first microphone. The method may also include where the first microphone is a part of a mobile computer device located at times within a home at the first location.

A further enhancement of the method may include where the plurality of sensor information including one or more digital images of the first location or LIDAR (light detection and ranging) images of the first location.

A further enhancement of the method may include where the plurality of sensor information including information about one or more intelligent devices connected to a home wireless network. The method may also include where the plurality of sensor information further includes information about one or more items connected to the one or more intelligent devices. The method may further include the one or more processors are programmed to identify a plurality of items at or near a home located at the first location, wherein the plurality of sensor information includes operational data of the one or more items.

A further enhancement of the method may include where the plurality of new information includes at least one of usage information of the first item and environmental information for at least one of the first item and the first location. The method may also include where the plurality of new information includes audio of the first item in operation. The method may also include where the plurality of new information includes weather information.

A further enhancement of the method may include where the at least one notification includes a video on how to perform the one or more maintenance tasks.

A further enhancement of the method may generate a model using a plurality of historical data, a plurality of operational data of a plurality of related items, a plurality of historical maintenance data of the plurality of related items, and a plurality of historical performance data of the plurality of related items. The method may also train the model to identify operational trends for items. The method may further include where the received plurality of new information includes operational data for the first item. The method may execute the model with operational data for the first item to adjust the schedule for the one or more maintenance tasks.

In still another aspect, a non-transitory computer readable medium having computer-executable instructions embodied thereon for evaluating aspects of health of a residential property may be provided. When executed by at least one processor and/or associated transceiver, the computer-executable instructions cause the at least one processor and/or associated transceiver to: (i) receive a plurality of sensor information for a first location; (ii) identify a first item at the first location based upon the plurality of sensor information; (iii) determine one or more maintenance tasks and a schedule for the one or more maintenance tasks for the first item; (iv) receive a plurality of new information about the first item; (v) adjust the schedule for the one or more maintenance tasks based upon the received plurality of new information; and/or (vi) transmit at least one notification for the one or more maintenance tasks to a user computer device associated with a user associated with the first location. The computer readable medium may have instructions that direct additional, less, or alternate functionality, including that discussed elsewhere herein.

### Additional Considerations

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, NoSQL, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system comprising one or more processors in communication with one or more memory devices, wherein the one or more processors are programmed to:
receive a plurality of sensor information for a first location;
identify a first item at the first location based upon the plurality of sensor information;
determine one or more maintenance tasks and a schedule for the one or more maintenance tasks for the first item;
receive a plurality of new information about the first item;
adjust the schedule for the one or more maintenance tasks based upon the received plurality of new information; and
transmit at least one notification for the one or more maintenance tasks to a user computer device associated with a user associated with the first location.

2. The computer system in accordance with claim 1, wherein the plurality of sensor information including noise information received by a first microphone at the first location and related to one or more items located near the first microphone.

3. The computer system in accordance with claim 2, wherein the first microphone is a part of a mobile computer device located at times within a home at the first location.

4. The computer system in accordance with claim 1, wherein the plurality of sensor information including one or more digital images of the first location or LIDAR (light detection and ranging) images of the first location.

5. The computer system in accordance with claim 1, wherein the plurality of sensor information including information about one or more intelligent devices connected to a home wireless network.

6. The computer system in accordance with claim 5, wherein the plurality of sensor information further includes information about one or more items connected to the one or more intelligent devices.

7. The computer system in accordance with claim 6, wherein the one or more processors are programmed to identify a plurality of items at or near a home located at the first location, wherein the plurality of sensor information includes operational data of the one or more items.

8. The computer system in accordance with claim 1, wherein the plurality of new information includes at least one of usage information of the first item and environmental information for at least one of the first item and the first location.

9. The computer system in accordance with claim 8, wherein the plurality of new information includes audio of the first item in operation.

10. The computer system in accordance with claim 8, wherein the plurality of new information includes weather information.

11. The computer system in accordance with claim 1, wherein the at least one notification includes a video on how to perform the one or more maintenance tasks.

12. The computer system in accordance with claim 1, wherein the one or more processors are programmed to:
generate a model using a plurality of historical data, a plurality of operational data of a plurality of related items, a plurality of historical maintenance data of the plurality of related items, and a plurality of historical performance data of the plurality of related items; and
train the model to identify operational trends for items.

13. The computer system in accordance with claim 12, wherein the received plurality of new information includes operational data for the first item, and wherein the one or more processors are further programmed to execute the model with operational data for the first item to adjust the schedule for the one or more maintenance tasks.

14. A computer-implemented method, the method implemented by a computer device comprising one or more processors in communication with one or more memory devices, wherein the method comprises:
receiving, by the one or more processors, a plurality of sensor information for a first location;
identifying, by the one or more processors, a first item at the first location based upon the plurality of sensor information;
determining, by the one or more processors, one or more maintenance tasks and a schedule for the one or more maintenance tasks for the first item;
receiving, by the one or more processors, a plurality of new information about the first item;
adjusting, by the one or more processors, the schedule for the one or more maintenance tasks based upon the received plurality of new information; and
transmitting, by the one or more processors, at least one notification for the one or more maintenance tasks to a user computer device associated with a user associated with the first location.

15. The computer-implemented method of claim 14, wherein the plurality of sensor information including noise information received by a first microphone at the first location and related to one or more items located near the first microphone.

16. The computer-implemented method of claim 15, wherein the first microphone is a part of a mobile computer device located at times within a home at the first location.

17. The computer-implemented method of claim 14, wherein the plurality of sensor information including one or more digital images of the first location or LIDAR (light detection and ranging) images of the first location.

18. The computer-implemented method of claim 14, wherein the plurality of sensor information includes information about one or more intelligent devices connected to a home wireless network and information about one or more items connected to the one or more intelligent devices, and wherein the method further comprises identifying a plurality of items at or near a home located at the first location, wherein the plurality of sensor information includes operational data of the one or more items.

19. The computer-implemented method of claim 14, wherein the plurality of new information includes at least one of usage information of the first item and environmental information for at least one of the first item and the first location, wherein the plurality of new information includes at least one of audio of the first item in operation and weather information.

20. At least one non-transitory computer-readable media having computer-executable instructions embodied thereon, wherein when executed by a computing device including at least one processor in communication with at least one memory device, the computer-executable instructions cause the at least one processor to:
receive a plurality of sensor information for a first location;
identify a first item at the first location based upon the plurality of sensor information;
determine one or more maintenance tasks and a schedule for the one or more maintenance tasks for the first item;
receive a plurality of new information about the first item;
adjust the schedule for the one or more maintenance tasks based upon the received plurality of new information; and
transmit at least one notification for the one or more maintenance tasks to a user computer device associated with a user associated with the first location.
